(19) United States
(12) Patent Application Publication
(10) Pub. No.: US 2007/0162676 A1
(43) Pub. Date: Jul. 12, 2007

(54) Adapter Element, Conversion Apparatus and Conversion Method

(76) Inventors: Yung-Huan Hsu, Hsinchu City (TW); Mei-Chuan Lu, Taichung City (TW)

Correspondence Address: LAW OFFICES OF LAI & ASSOCIATES, P.C., STE 200, 5800 RANCHESTER, HOUSTON, TX, 77036, US

(21) Appl. No.: 11/609,199

(22) Filed: Dec. 11, 2006

(30) Foreign Application Priority Data
Jan. 6, 2006 (TW) 095119460

(51) Int. Cl. G06F 13/00

(52) U.S. Cl. 710/301

(57) ABSTRACT

An adapter element, a conversion apparatus and a conversion method are applied in an electrical connection between a memory element and an electronic apparatus for transmitting data. The switch apparatus includes a first interface, a second interface and a processor. A first adapter element is inserted into the first interface. A second adapter element is inserted into the second interface. When the memory element or the electronic apparatus is replaced, the first adapter element or the second adapter element is also replaced. The processor then detects formats for the first adapter element and the second adapter element to perform format conversions in transmitting data between the first interface and the second interface. Therefore, the conversion apparatus could support different memory elements or different electronic apparatuses.

### FIELD OF THE INVENTION

The present invention relates to an adapter element, a conversion apparatus and a conversion method, and more particularly to an adapter element, a conversion apparatus and a conversion method that adopt a mechanism of replacing an adapter element to support different memory elements or electronic apparatuses.

### BACKGROUND OF THE INVENTION

As science and technology advances, the development and application of an electronic apparatus including a multimedia player (including a MP3 player, a MP4 player or a PMP), a personal digital assistant, (PDA), a digital camera, a digital camcorder or a computer are diversified and the electronic apparatuses can be operated together with an external or a built-in memory element such as a memory card, a hard disk or a flash drive to enhance the data storage capacity or functions. Most personal digital assistants (PDA), MP3 players or PMPs available in the market provide a universal serial bus (USB) interface and one or two kinds of memory card slots, and most digital cameras usually provide a memory card slot and a USB interface or an IEEE-1394 serial port. Since there are various different formats of memory cards developed according to each manufacturer's business consideration and technological advancement, an electronic apparatus usually cannot support several different memory cards at the same time. Alternatively, the price of a built-in apparatus which supports different memory cards will be very high. Therefore, the derived products including adapters and card readers are developed to solve the problem that the interface or slot of an electronic apparatus cannot support memory cards of different formats.

Referring to FIGS. 1 and 2 for a schematic block diagram and a perspective view of a traditional card reader respectively, the card reader 1 comprises a first inserting portion 11, a second inserting portion 12, a switching unit 13 and an interface 14, wherein the first inserting portion 11 and the second inserting portion 12 are provided for inserting different types of memory cards, and the switching unit 13 is connected separately to the first inserting portion 11, the second inserting portion 12 and the interface 14 for electrically conducting the interface 14 by the first inserting portion 11 or the second inserting portion 12, and the interface 14 can transmit data with a memory card in the first inserting portion 11 or the second inserting portion 12 that is electrically conducted by the switching unit 13. If the electronic apparatus has a port corresponding to the interface 14, then the corresponding memory card of the first inserting portion 11 or the second inserting portion 12 can access data of the electronic apparatus through the card reader.

Referring to FIGS. 3 and 4 for an exploded view and a perspective view of a traditional adapter, the adapter 3 comprises a housing 31, a circuit substrate 32 and an adapter terminal 33, wherein the housing 31 has a hollow portion 312 and a hollow structure, and the hollow structure has a slot 311 for containing the circuit substrate 32. A side of the circuit substrate 32 has a plurality of goldfingers corresponding to the hollow portion 312 and exposed from the hollow portion 312, and another side of the circuit substrate 32 has a plurality of pins 321. An end of the adapter terminal 33 is a soldering portion 331 soldered with the pins 321 of the circuit substrate 32, and another end of the adapter terminal 33 is a guided connecting portion 332 connected to an electric contact point in the slot 311. If the electronic apparatus has a transmission interface corresponding to the goldfingers and the memory card is inserted into the slot 311, a memory card will be able to access data of the electronic apparatus through the adapter terminal 33 and the circuit substrate 32.

The main function of the foregoing card reader simply allows the electronic apparatus to read data of different memory cards. Since the transmission interfaces of the electronic apparatus are different, therefore the card reader cannot connect various different electronic apparatuses, or the card reader can add a plurality of interfaces to broaden the scope of applicability of the electronic apparatus. However, adding interfaces and inserting portions not only incurs a higher manufacturing cost of the card reader, but also increases the volume of the card reader that may cause inconvenience for its carrying and storage. The aforementioned adapter mainly improves the scope of applicability of the memory card. Since the manufacturing technology of memory cards changes day after day, therefore there are increasingly more formats of the memory cards. If a consumer's personal digital assistant, (PDA), multimedia player and digital camera provide different memory card slots, then the consumer has to purchase several different types of memory cards or use an adapter. However, the adapter simply serves as an interface for converting a fixed format of the memory card into another format, but such function no longer can meet the requirements of a consumer having several different electronic apparatuses.

In view of the foregoing problems, the inventor of the present invention based on years of experience from conducting research and experiments in the related industry, invents an adapter element, a conversion apparatus and a conversion method to solve the foregoing problems.

### SUMMARY OF THE INVENTION

Therefore, it is a primary object of the present invention to provide an adapter element, a conversion apparatus and a conversion method, and more particularly a mechanism capable of replacing an adapter element to support different types of memory elements or electronic apparatuses, so as to effectively broaden the scope of applicability of the memory elements and the selection of memory elements for the electronic apparatus.

To achieve the foregoing object, the conversion apparatus of the invention comprises a first interface, a second interface and a processor, wherein the first interface is provided for inserting a first adapter element, and the second interface is provided for inserting a second adapter element, and the first adapter element and the second adapter element are provided for connecting the memory element and the electronic apparatus. The processor is electrically connected to the first interface and the second interface for detecting the formats of the first adapter element and the second adapter element, and the formats of the first and second adapter elements are used for controlling data transmission between the first interface and the second interface. If the memory element or electronic apparatus is replaced, then the first adapter element or second adapter element will be replaced accordingly, such that the conversion apparatus can support different memory elements or different electronic apparatuses.

Since the first terminal of the first adapter element in accordance with the present invention has an interface or a slot with a CE-ATA, SATA, PATA, SCSI, RS-232, RS-485, IEEE-1394 or USB format, and the second terminal of the first adapter element can be electrically connected with the first interface. The first terminal of the second adapter element has an interface or a slot with a CE-ATA, SATA, PATA, SCSI, RS-232, RS-485, IEEE-1394 or USB format, and the second terminal of the second adapter element can be electrically connected with the second interface. Therefore, the memory element electrically connected to the first terminal of the first adapter element could be a SD (secure digital) memory card, a CF (compact flash) memory card, a MS (memory stick) card, a XD memory card, a T-Flash (trans-flash) card, a MMC (multimedia) card, a mini hard disk, a flash drive or a portable hard disk, and the electronic apparatus electrically connected to the first terminal of the second adapter element could be a personal digital assistant (PDA), a multimedia player, a digital camera, a digital camcorder or a computer.

To make it easier for our examiner to understand the technical characteristics and performance of the present invention, we use preferred embodiments together with accompanying drawings for the detailed description of the invention.

### BRIEF DESCRIPTION OF THE DRAWINGS

FIG. 1 is a schematic block diagram of a traditional card reader;

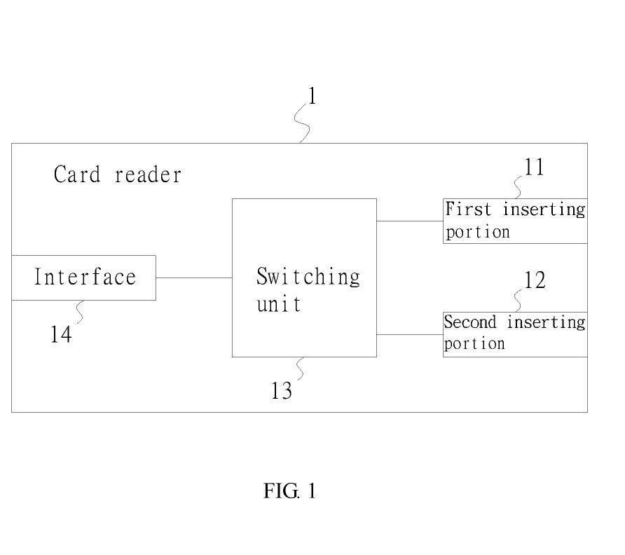

FIG. 2 is a perspective view of a traditional card reader;

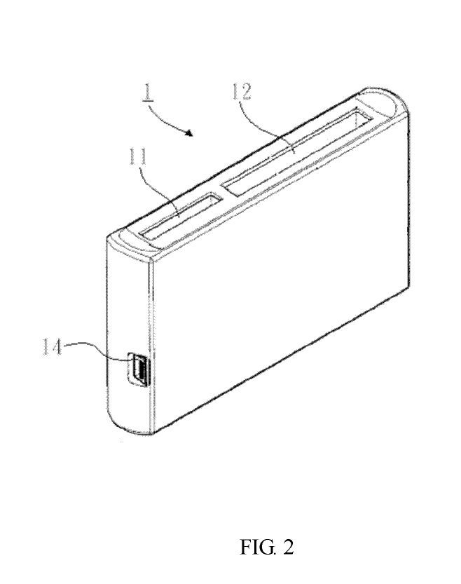

FIG. 3 is an exploded view of a traditional adapter;

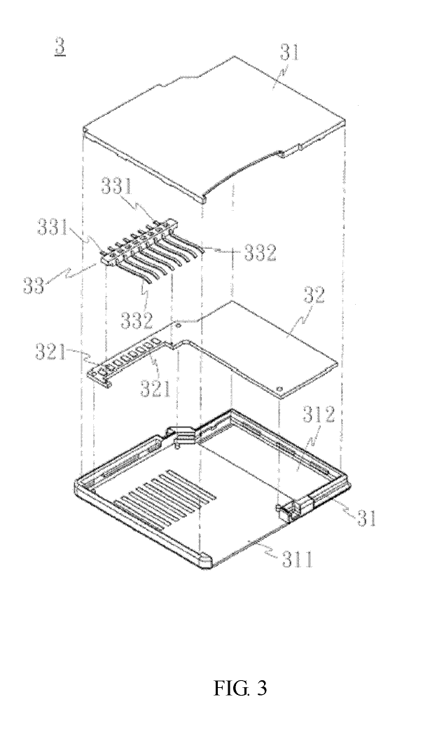

FIG. 4 is a schematic view of a traditional adapter;

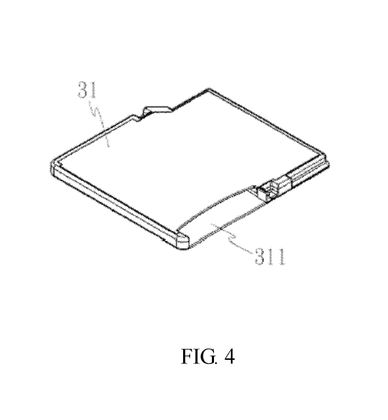

FIG. 5 for a schematic block diagram of a conversion apparatus and an adapter element in accordance with the present invention;

FIG. 6 is a perspective view of a conversion apparatus and an adapter element in accordance with a preferred embodiment of the present invention;

FIG. 7 is a flow chart of a conversion method in accordance with the present invention; and

FIG. 8 is a flow chart of a conversion method in accordance with a preferred embodiment of the present invention.

### DETAILED DESCRIPTION OF THE PREFERRED EMBODIMENTS

The above and other objects, features and advantages of the present invention will become apparent from the following detailed description of preferred embodiments taken with the accompanying drawings, and a same numeral is used to indicate a same element for the illustration.

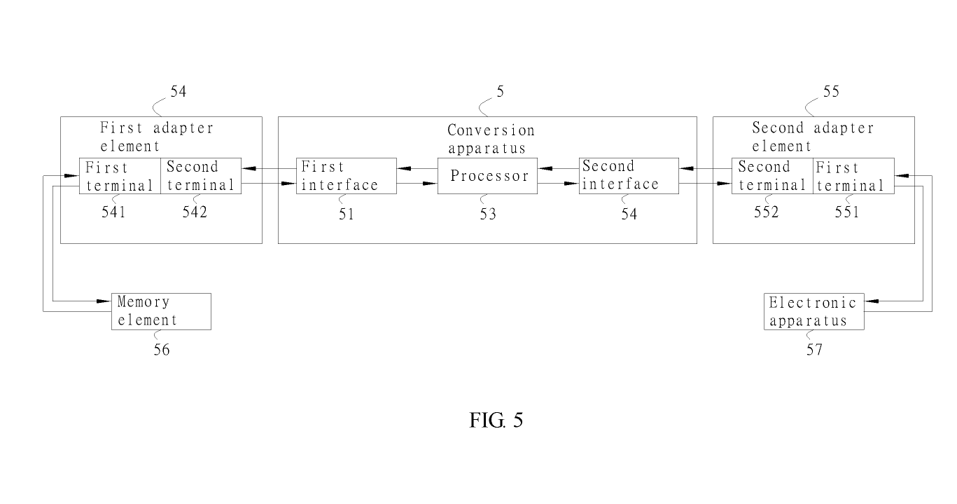

Referring to FIG. 5 for a schematic block diagram of a conversion apparatus and an adapter element in accordance with the present invention, the conversion apparatus 5 comprises a first interface 51, a second interface 52 and a processor 53, and the adapter element includes a first adapter element 54 and a second adapter element 55. The first interface 51 is provided for inserting a first adapter element 54, and the second interface 52 is provided for inserting a second adapter element 55. A first terminal 541 of the first adapter element 54 has an interface or a slot with a CE-ATA, SATA, PATA, SCSI, RS-232, RS-485, IEEE-1394 or USB format for connecting a memory element 56. A second terminal 542 of the first adapter element 54 has contact points electrically connected to pins of the first interface 51. A first terminal 551 of the second adapter element 55 has an interface or a slot with a CE-ATA, SATA, PATA, SCSI, RS-232, RS-485, IEEE-1394 or USB format for connecting an electronic apparatus 57. A second terminal 552 of the second adapter element 55 has contact points electrically connected to pins of the second interface 52. The processor 53 is electrically connected to the first interface 51 and the second interface 52, and the first interface 51 and the second interface 52 are provided for detecting the formats of the first adapter element 54 and the second adapter element 55, and the formats of the first adapter element 54 and the second adapter element 55 are used for controlling the electric connection of the pins between the first interface 51 and the second interface 52 and data transmission between the first interface 51 and the second interface 52. If the memory element 56 or the electronic apparatus 57 is replaced, it is necessary to simply replace the first adapter element 54 or the second adapter element 55, such that the conversion apparatus 5 can support different memory elements 56 or different electronic apparatuses 57. The formats of the first interface 51 and the second interface 52 can be the same or different, and the processor 53 is preferably an integrated circuit, and the memory element 56 is preferably a SD memory card, a CF memory card, a MS card, a XD memory card, a T-Flash card, a MMC card, a mini hard disk, a flash drive or a portable hard disk, and the electronic apparatus 57 is preferably a personal digital assistant, (PDA), a multimedia player, a digital camera, a digital camcorder or a computer. The first terminal 541 and the second terminal 542 of the first adapter element 54 can be connected by a flat cable as needed. Similarly, the first terminal 551 and the second terminal 552 of the second adapter element 55 can be connected by a flat cable as needed for improving the convenience of its application.

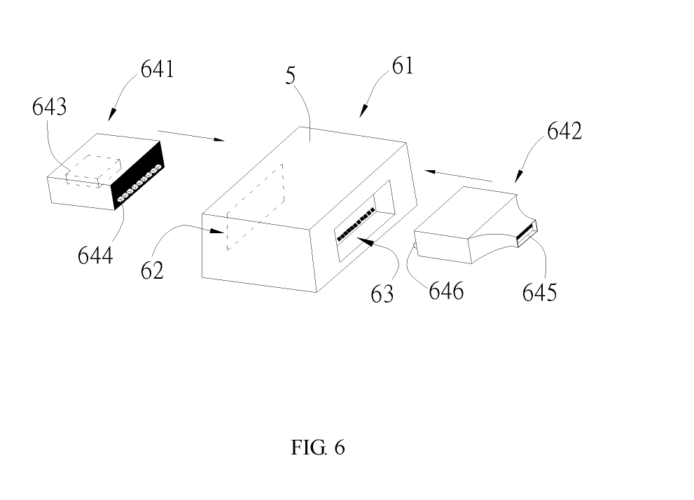

Referring to FIG. 6 for a perspective view of a conversion apparatus and an adapter element in accordance with a preferred embodiment of the present invention, the conversion apparatus 5 comprises a housing 61 for containing an integrated circuit (not shown in the figure) with detection and control functions, and the housing 61 includes two openings 62, 63, one having a first interface 51, and the other one having a second interface 52, and the first interface 51 and the second interface 52 are electrically connected to the integrated circuit in the housing 61, and the mechanical structure and electric format of the first interface 51 are the same as those of the second interface 52. The adapter element could include an adapter element 641 of a SD memory card and a USB adapter element 642, wherein the adapter element 641 of the SD memory card has a SD memory card slot 643 and a connecting terminal 644 corresponding to the first interface 51, and the USB adapter element 642 has a USB interface 645 and a connecting terminal 646 corresponding to the second interface 52. If the adapter element 641 of the SD memory card is inserted to the first interface 51 through the connecting terminal 644, and the USB adapter element 642 is inserted to the second interface 52 through the connecting terminal 646, it is necessary to simply insert the SD memory card into the SD memory card slot 643 for connecting the corresponding USB interface of the electronic apparatus 57 through the USB interface 645, such that the electronic apparatus 57 can access data from the SD memory card. Since the adapter element is replaceable, therefore users can purchase a corresponding adapter element according to their memory card 56 and electronic apparatus 57 to achieve the effects of increasing the convenience with a lower cost and broadening the scope of applicability of the SD memory card effectively.

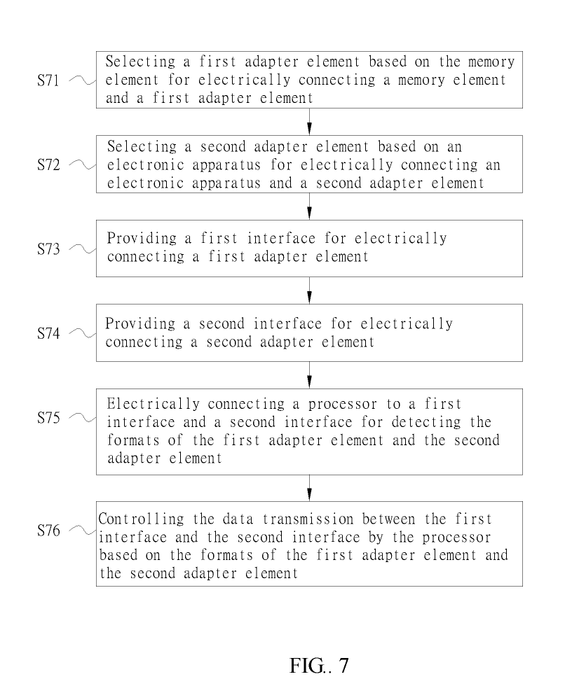

Referring to FIG. 7 for a flow chart of a conversion method in accordance with the present invention used for electrically connecting a memory element and an electronic apparatus and transmitting data, the method comprises the steps of:

Step S71: selecting a first adapter element based on the memory element for electrically connecting a memory element and a first adapter element;

Step S72: selecting a second adapter element based on an electronic apparatus for electrically connecting an electronic apparatus and a second adapter element;

Step S73: providing a first interface for electrically connecting a first adapter element;

Step S74: providing a second interface for electrically connecting a second adapter element;

Step S75: electrically connecting a processor to a first interface and a second interface for detecting the formats of the first adapter element and the second adapter element; and

Step S76: controlling the data transmission between the first interface and the second interface by the processor based on the formats of the first adapter element and the second adapter element.

In the foregoing steps, the first interface and the second interface have a same specification or different specifications; the processor is preferably an integrated circuit; the memory element is preferably a SD memory card, a CF memory card, a MS memory card, a XD memory card, a T-Flash card, a MMC card, a mini hard disk, a flash drive or a portable hard disk; and the electronic apparatus is preferably a personal digital assistant, (PDA), a multimedia player, a digital camera, a digital camcorder or a computer.

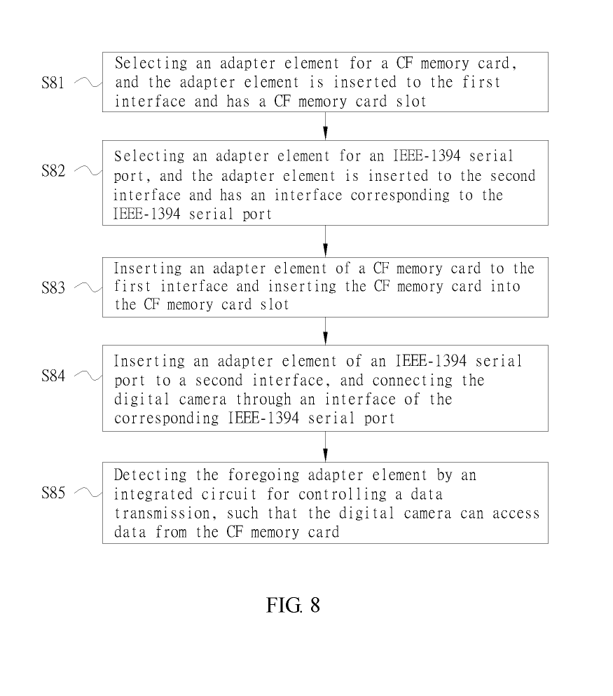

Referring to FIG. 8 for a flow chart of a conversion method in accordance with a preferred embodiment of the present invention for electrically connecting a CF memory card with a digital camera having an IEEE-1394 serial port and transmitting data, the method comprises the steps of:

Step S81: selecting an adapter element for a CF memory card, and the adapter element is inserted to the first interface and has a CF memory card slot;

Step S82: selecting an adapter element for an IEEE-1394 serial port, and the adapter element is inserted to the second interface and has an interface corresponding to the IEEE-1394 serial port;

Step S83: inserting an adapter element of a CF memory card to the first interface and inserting the CF memory card into the CF memory card slot;

Step S84: inserting an adapter element of an IEEE-1394 serial port to a second interface, and connecting the digital camera through an interface of the corresponding IEEE-1394 serial port; and

Step S85: detecting the foregoing adapter element by an integrated circuit for controlling a data transmission, such that the digital camera can access data from the CF memory card.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A conversion apparatus, used for an electric connection and a data transmission between a memory element and an electronic apparatus, comprising:
a first interface, for inserting a first adapter element, and said first adapter element configured to electrically connect said memory element;
a second interface, for inserting a second adapter element, and said second adapter element configured to electrically connect said electronic apparatus; and
a processor, electrically connected to said first interface and said second interface, for detecting formats of said electrically connected first adapter element and second adapter element to perform a format conversion between said first interface and said second interface for transmitting data;
thereby, if said memory element or said electronic apparatus is replaced, said first adapter element or said second adapter element can be replaced accordingly for said conversion apparatus to support different memory elements or different electronic apparatuses.

2. The conversion apparatus of claim 1, wherein said memory element is a SD memory card, a CF memory card, a MS card, a XD memory card, a T-Flash card, a MMC card, a mini hard disk, a flash drive or a portable hard disk.

3. The conversion apparatus of claim 1, wherein said electronic apparatus is a personal digital assistant, (PDA), a multimedia player, a digital camera, a digital camcorder or a computer.

4. The conversion apparatus of claim 1, wherein said first adapter element or said second adapter element has a CE-ATA, SATA, PATA, SCSI, RS-232, RS-485, IEEE-1394 or USB format.

5. The conversion apparatus of claim 1, wherein said first interface and said second interface have a plurality of pins, and said processor controls an electric connection between said pins based on the formats of said first adapter element and said second adapter element and performs a format conversion for transmitting data.

6. The conversion apparatus of claim 1, wherein said processor is an integrated circuit.

7. The conversion apparatus of claim 1, wherein said first adapter element includes a flat cable.

8. The conversion apparatus of claim 1, wherein said second adapter element includes a flat cable.

9. An adapter element, used for inserting a conversion apparatus, and said conversion apparatus being provided for inserting a plurality of adapter elements for electrically connecting a memory element and an electronic apparatus and transmitting data between said memory element and said electronic apparatus, and said adapter element comprising:
a first terminal, electrically connected to said memory element or said electronic apparatus; and
a second terminal, inserted into said conversion apparatus;
thereby, said first terminal and said second terminal of said plurality of adapter elements electrically connect said conversion apparatus with said memory element and said electronic apparatus for electrically connecting said memory element and said electronic apparatus and transmitting data.

10. The adapter element of claim 9, wherein said memory element is a SD memory card, a CF memory card, a MS card, a XD memory card, a T-Flash card, a MMC card, a mini hard disk, a flash drive or a portable hard disk.

11. The adapter element of claim 9, wherein said electronic apparatus is a personal digital assistant, (PDA), a multimedia player, a digital camera, a digital camcorder or a computer.

12. The adapter element of claim 9, wherein said first terminal has a CE-ATA, SATA, PATA, SCSI, RS-232, RS-485, IEEE-1394 or USB format.

13. The adapter element of claim 9, wherein said first terminal and said second terminal are connected by a flat cable.

14. A conversion method, used for electrically connecting a memory element and an electronic apparatus and transmitting data between said memory element and said electronic apparatus, and said conversion method comprising:
selecting a first adapter element based on said memory element, for electrically connecting said memory element and said first adapter element;
selecting a second adapter element based on said electronic apparatus, for electrically connecting said electronic apparatus and said second adapter element;
providing a first interface for electrically connecting said first adapter element;
providing a second interface for electrically connecting said second adapter element;
detecting formats of said first adapter element and said second adapter element by electrically connecting a processor with said first interface and said second interface; and
controlling the data transmission between said first interface and said second interface based on the formats of said first adapter element and said second adapter element.

15. The conversion method of claim 14, wherein said memory element is a SD memory card, a CF memory card, a MS card, a XD memory card, a T-Flash card, a MMC card, a mini hard disk, a flash drive or a portable hard disk.

16. The conversion method of claim 14, wherein said electronic apparatus is a personal digital assistant, (PDA), a multimedia player, a digital camera, a digital camcorder or a computer.

17. The conversion method of claim 14, wherein said first adapter element or said second adapter element has a CE-ATA, SATA, PATA, SCSI, RS-232, RS-485, IEEE-1394 or USB format.

18. The conversion method of claim 14, wherein said first interface and said second interface have a plurality of pins, and said processor controls an electric connection between said pins based on the formats of said first adapter element and said second adapter element and performs a format conversion for transmitting data.

19. The conversion method of claim 14, wherein said processor is an integrated circuit.
